(19) United States
(12) Patent Application Publication
(10) Pub. No.: US 2026/0087599 A1
(43) Pub. Date: Mar. 26, 2026

(54) SPECKLE FILTERING IN IMAGE PROCESSING

(71) Applicant: QUALCOMM Incorporated, San Diego, CA (US)

(72) Inventors: Bhupinder Singh Parhar, Escondido, CA (US); Nicolas Antoine, La Jolla, CA (US); Gabriel Aaron Pilloud, Poulsbo, WA (US); Anwika Bhandary, San Diego, CA (US); Manu Prakash, Cork (IE); Eric Lutz, San Diego, CA (US); Anil Kumar Gokavarapu, San Diego, CA (US)

(21) Appl. No.: 18/894,476

(22) Filed: Sep. 24, 2024

(51) Int. Cl. G06T 5/70; G06T 7/00; G06T 7/246; G06T 7/60; H04N 25/60

(52) U.S. Cl. CPC G06T 5/70; G06T 7/0002; G06T 7/248; G06T 7/60; G06T 2207/30168; H04N 25/60

(57) ABSTRACT

One or more processors of a computing device may determine, for each of a plurality of columns in a window associated with a subject pixel in an image, one or more partial speckle regions. The one or more processors may determine, based on the one or more partial speckle regions for each of the plurality of columns, a speckle size of the subject pixel. The one or more processors may determine, based on the speckle size of the subject pixel, to remove noise associated with the subject pixel from the image and may remove the noise associated with the subject pixel from the image.

### TECHNICAL FIELD

This disclosure relates to image processing.

### BACKGROUND

A camera device includes one or more cameras that capture frames (e.g., images). Examples of the camera device include stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” smartwatch, a device equipped with own camera, a device configured to control another device equipped with a camera, or any device with digital imaging or video capabilities. A camera device processes the captured frames and outputs the frames for display. In some examples, the camera device controls the exposure, focus, and white balance to capture high quality images.

An image frame captured by the camera device may include speckles. A speckle is an area composed of interconnected pixels within the image frame. The camera device may implement a speckle filter to remove, from the image, speckle regions having a size that is below a certain threshold. To determine the size of a speckle region, the camera device determines a connection between adjacent pixels. The connection between two adjacent pixels is defined based on computing the difference between the motion vectors of the two pixels. A small difference between the motion vectors may be indicative of a connection between the two pixels, while a large difference may be indicative of a disconnection between the two pixels.

### SUMMARY

In general, this disclosure describes techniques for implementing a speckle filter that is able to more quickly and efficiently determine speckles in an image and to filter speckles from the image. A speckle region is an area of an image composed of interconnected pixels which may be noise in the image. Pixels having similar motion vector values in an image may be connected to form speckle regions. Small areas of interconnected pixels may be noise in the image that can be removed to improve the quality of the image, while larger areas of interconnected pixels may be part of an object that is captured in the image and should not be removed from the image.

Processing circuitry of a computing device may determine whether a pixel is noise in the image and should be removed based on a speckle size associated with the image. Pixels having relatively smaller speckle sizes may be more likely to be noise, and the processing circuitry may remove such pixels having relatively smaller speckle sizes.

In accordance with aspects of this disclosure, the processing circuitry may, for each pixel in an image, determine the speckle size of the image and may determine, based on the speckle size of a pixel, a corresponding confidence level. A low confidence level of a pixel may be indicative of the pixel being noise that should be removed from the image, and a high confidence level of a pixel may be indicative of the pixel not being noise. The processing circuitry may determine whether to remove the pixel from the image based on the corresponding confidence level. Removing a pixel from the image may include changing the pixel values of the pixel in order to remove noise from the pixel of the image.

The processing circuitry may determine a window associated with a subject pixel and determine the speckle size of the window using the window. The window may center on the subject pixel and may include the subject pixel as well as neighboring pixels in the image. The window includes a plurality of columns of pixels, and the processing circuitry may, determine, for each of the plurality of columns in the window, one or more partial speckle regions. A partial speckle region for a column may be one or more interconnected pixels in the column, and each of the columns may include a corresponding one or more partial speckle regions.

The processing circuitry may determine, based on the one or more partial speckle regions for each of the plurality of columns, a speckle size of the subject pixel. For example, the processing circuitry may connect the one or more partial speckle regions for each of the plurality of columns into a plurality of speckle regions in the window, and may determine the speckle size of the subject pixel based on the number of pixels in the speckle region that includes the subject pixel.

The processing circuitry may, based on the speckle size of the subject pixel, determine a confidence level of the pixel, and may determine whether to remove noise associated with the subject pixel from the image based on the confidence level of the pixel. As described above, a smaller speckle size of a pixel may be indicative of the pixel being noise in the image. The processing circuitry may, based on determining to remove noise associated with the subject pixel, remove noise associated with the subject pixel from the image. For example, the processing circuitry may perform one or more denoising techniques to update the pixel values of the subject pixel to remove noise associated with the subject pixel from the image.

In some aspects, the techniques described herein relate to a computing device including: one or more memories configured to store an image; and one or more processors implemented in circuitry, coupled to the one or more memories, and configured to: determine, for each of a plurality of columns in a window centered on a subject pixel in the image, one or more partial speckle regions; determine, based on the one or more partial speckle regions for each of the plurality of columns, a speckle size of the subject pixel; determine, based on the speckle size of the subject pixel, to remove noise associated with the subject pixel from the image; and remove the noise associated with the subject pixel from the image.

In some aspects, the techniques described herein relate to a method including: determining, with one or more processors and for each of a plurality of columns in a window centered on a subject pixel in an image, one or more partial speckle regions; determining, with the one or more processors and based on the one or more partial speckle regions for each of the plurality of columns, a speckle size of the subject pixel; determining, with the one or more processors and based on the speckle size of the subject pixel, to remove noise associated with the subject pixel from the image; and removing, with the one or more processors, the noise associated with the subject pixel from the image.

In some aspects, the techniques described herein relate to a computer-readable storage medium storing instructions thereon that when executed cause one or more processors to: determine, for each of a plurality of columns in a window centered on a subject pixel in an image, one or more partial speckle regions; determine, based on the one or more partial speckle regions for each of the plurality of columns, a speckle size of the subject pixel; determine, based on the speckle size of the subject pixel, to remove noise associated with the subject pixel from the image; and remove the noise associated with the subject pixel from the image.

In some aspects, the techniques described herein relate to an apparatus including: means for determining, for each of a plurality of columns in a window centered on a subject pixel in an image, one or more partial speckle regions; means for determining, based on the one or more partial speckle regions for each of the plurality of columns, a speckle size of the subject pixel; means for determining, based on the speckle size of the subject pixel, to remove noise associated with the subject pixel from the image; and means for based on the confidence level of the subject pixel, removing the noise associated with the subject pixel from the image.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram of a device configured to perform speckle filtering according to the techniques of this disclosure.

FIG. 2 illustrates an example image for which speckle sizes of pixels can be determined, in accordance with the techniques of this disclosure.

FIG. 3 illustrates an example technique for determining the speckle size of a subject pixel based on an associated window centered on the subject pixel, in accordance with aspects of this disclosure.

FIG. 4 is a block diagram illustrating example hardware units of processing circuitry configured to determine speckle sizes of pixels, in accordance with the techniques of this disclosure.

FIG. 5 illustrates bitmasks for encoding labeling information for columns in a window, in accordance with the techniques of this disclosure.

FIG. 6 is a block diagram illustrating example hardware units of processing circuitry configured to store a connection map, in accordance with the techniques of this disclosure.

FIG. 7 is a block diagram illustrating example hardware units of processing circuitry configured to determine speckle sizes of pixels, in accordance with the techniques of this disclosure.

FIG. 8 is a flowchart showing an example method of operation according to the techniques of this disclosure.

### DETAILED DESCRIPTION

The example techniques described in this disclosure relate to performing speckle filtering of images. A speckle region is an area of an image composed of interconnected pixels which may be noise in the image. Small areas of interconnected pixels may be noise in the image that can be removed to improve the quality of the image, while larger areas of interconnected pixels may be part of an object that is captured in the image and should not be removed from the image.

Processing circuitry may process an image to determine interconnections between pixels of the image to identify speckle regions. The processing circuitry may calculate a corresponding motion vector value for each pixel in the image and may determine interconnections between two adjacent pixels based on the difference between the motion vector values of the adjacent pixels. A small difference between the motion vectors may be indicative of a connection between the two pixels, while a large difference may be indicative of a disconnection between the two pixels. The processing circuitry may determine that two adjacent pixels are connected if the difference between the motion vector values of the two pixels is equal to or below a specified threshold, and may determine that two adjacent pixels are not connected if the difference between the motion vector values of the two pixels is larger than the specified threshold.

However, identifying speckle regions in an image by determining interconnections between pixels of the image may be relatively processor intensive, such as by requiring a large amount of processor cycles and processing time, and memory intensive. Further, a large amount of hardware units and other complex hardware in the processing circuitry may also be needed to identify speckle regions in an image by determining interconnections between pixels of the image. In addition, interconnected pixels within an image may have random shapes and sizes, which may further increase the challenge of identifying speckle regions in an image.

For example, one technique for identifying speckle regions may include, for each pixel in an image, building a linked list of connected pixels and computing the size of the linked list to determine the size of interconnected pixels (e.g., speckle region) that includes the pixel. The processing circuitry may, for the pixel, determine, based on corresponding motion vector values, whether each neighboring pixel is connected to the pixel. The processing circuitry may add each neighboring pixel determined to connect to the pixel to the linked list and may, for each of these pixels, determine whether each of their neighboring pixels is connected, and so on, to build a linked list of connected pixels that form a speckle region in the image. As can be seen, such a technique may require a relatively large amount of processing cycles to determine interconnections between the pixels and may require a relatively large amount of memory to store the linked list.

In accordance with aspects of this disclosure, to reduce the processor resources and memory resources for performing speckle filtering and to simplify the hardware for performing speckle filtering, a processing circuitry may determine, for each pixel in an image, a speckle size of the pixel based on an associated window that centers on the pixel. The processing circuitry, may for a pixel, determine, for each of a plurality of columns in the associated window, one or more partial speckle regions. The processing circuitry may therefore determine, based on the one or more partial speckle regions for each of the plurality of columns, a speckle size of the subject pixel.

The speckle size of a pixel is indicative of whether the pixel is a speckle in the image that should be removed from the image. The processing circuitry may determine, based on the speckle size of the pixel, whether to remove the pixel from the image and may, based on determining that the pixel should be removed from the image, remove the pixel from the image.

The processing circuitry may determine one or more partial speckle regions in a single clock cycle. As such, the amount of processor cycles spent to determine a speckle size of a pixel may correspond to the number of columns in the window associated with the pixel, and may be fixed for each pixel in the image. Fixing amount of processor cycles that is spent to determine the speckle size of a pixel enables the processing circuitry to determine speckle sizes of pixels in a consistent and timely manner, Further, the techniques of this disclosure for performing speckle filtering of images may reduce memory requirements by not requiring processing circuitry to create a linked list and to store the linked list in memory. Instead, the processing circuitry may be able to efficiently store information, such as the sizes of partial speckle regions in the window, using bitmasks, which can be stored in registers of the processing circuitry.

In addition, the processing circuitry may simplify and reduce the complexity of hardware that performs the determination of speckle sizes of pixels. The processing circuitry may include, for each column in a support window, a corresponding hardware unit for determining one or more partial speckle regions in the column. The hardware units may operate in a pipelined fashion to process pixels and columns of pixels to determine the speckle size of a pixel, thereby also reducing the processing time to determine the speckle size of a pixel.

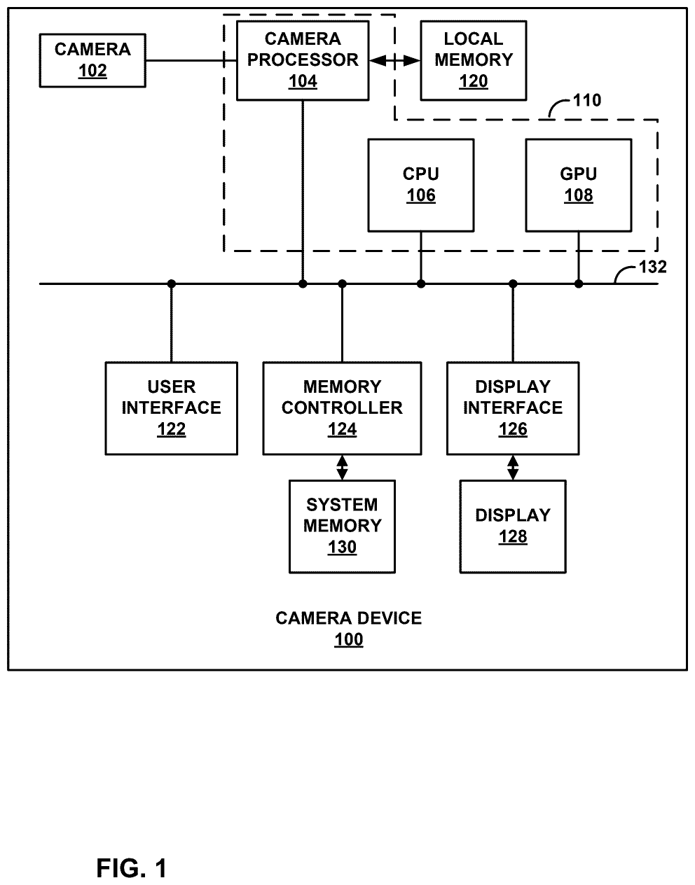

FIG. 1 is a block diagram of a device configured to perform speckle filtering according to the techniques of this disclosure. Examples of camera device 100 include processing systems in an automobile (e.g., an advance driver assistance system (ADAS)), processing systems in a robotics application, AR headsets, virtual reality (VR) headsets, stand-alone digital cameras or digital video camcorders, camera-equipped wireless communication device handsets, such as mobile telephones having one or more cameras, cellular or satellite radio telephones, camera-equipped personal digital assistants (PDAs), computing panels or tablets, gaming devices, computer devices that include cameras, such as so-called “web-cams,” or any device with digital imaging or video capabilities.

As illustrated in the example of FIG. 1, camera device 100 includes camera 102 (e.g., having a lens, a filter, and an image sensor), camera processor 104 and local memory 120 of camera processor 104, a central processing unit (CPU) 106, a graphical processing unit (GPU) 108, user interface 122, memory controller 124 that provides access to system memory 130, and display interface 126 that outputs signals that cause graphical data to be displayed on display 128. Camera processor 104, CPU 106, and GPU 108 are collectively referred to herein as one or more processors 110. That is, any combination of camera processor 104, CPU 106, and/or GPU 108 may perform the operations described herein as being performed by one or more processors 110.

Although the example of FIG. 1 illustrates camera device 100 including one camera 102, in some examples, camera device 100 may include a plurality of cameras 102, such as for omnidirectional image or video capture. Also, although camera device 100 is illustrated as including one camera processor 104, in some examples, there may be a plurality of camera processors (e.g., one for each of cameras 102) or one camera processor for each of one or more cameras 102.

Also, although the various components are illustrated as separate components, in some examples the components may be combined to form a system on chip (SoC). As an example, camera processor 104, CPU 106, GPU 108, and display interface 126 may be formed on a common integrated circuit (IC) chip. In some examples, one or more of camera processor 104, CPU 106, GPU 108, and display interface 126 may be in separate IC chips. Additional examples of components that may be configured to perform the example techniques include a digital signal processor (DSP). Various other permutations and combinations are possible, and the techniques should not be considered limited to the example illustrated in FIG. 1.

The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry. Examples of local memory 120 and system memory 130 include one or more volatile or non-volatile memories or storage devices, such as random access memory (RAM), static RAM (SRAM), dynamic RAM (DRAM), erasable programmable ROM (EPROM), electrically erasable programmable ROM (EEPROM), flash memory, a magnetic data media or an optical storage media.

The various units illustrated in FIG. 1 communicate with each other using bus 132. Bus 132 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. The specific configuration of buses and communication interfaces between the different components shown in FIG. 1 is merely exemplary, and other configurations of camera devices and/or other image processing systems with the same or different components may be used to implement the techniques of this disclosure.

Camera processor 104 receive camera frames (e.g., image frames) from camera 102, and process the camera frames to generate output frames for display. CPU 106, GPU 108, camera processor 104, or some other circuitry may be configured to process the output frame that includes image content generated by camera processor 104 into images for display on display 128. In some examples, GPU 108 may be further configured to render graphics content on display 128.

In some examples, camera processor 104 may be configured as an image processing pipeline. For instance, camera processor 104 may include a camera interface that interfaces between camera 102 and camera processor 104. Camera processor 104 may include additional circuitry to process the image content. Camera processor 104 outputs the resulting frames with image content (e.g., pixel values for each of the image pixels) to system memory 130 via memory controller 124.

CPU 106 may comprise a general-purpose or a special-purpose processor that controls operation of camera device 100. A user may provide input to camera device 100 to cause CPU 106 to execute one or more software applications. The software applications that execute on CPU 106 may include, for example, a media player application, a video game application, a graphical user interface application or another program. The user may provide input to camera device 100 via one or more input devices (not shown) such as a keyboard, a mouse, a microphone, a touch pad or another input device that is coupled to camera device 100 via user interface 122.

Memory controller 124 facilitates the transfer of data going into and out of system memory 130. For example, memory controller 124 may receive memory read and write commands, and service such commands with respect to system memory 130 in order to provide memory services for the components in camera device 100. Memory controller 124 is communicatively coupled to system memory 130. Although memory controller 124 is illustrated in the example of camera device 100 of FIG. 1 as being a processing circuit that is separate from both CPU 106 and system memory 130, in other examples, some or all of the functionality of memory controller 124 may be implemented on one or both of CPU 106 and system memory 130.

System memory 130 may store program modules and/or instructions and/or data that are accessible by camera processor 104, CPU 106, and GPU 108. For example, system memory 130 may store user applications, resulting frames from camera processor 104, etc. System memory 130 may additionally store information for use by and/or generated by other components of camera device 100. For example, system memory 130 may act as a device memory for camera processor 104.

One or more processors 110 are configured to obtain images (e.g., image frames), such as by receiving images from camera 102 or retrieving images from system memory 130, and to remove speckles from the images. A speckle region is an area of an image composed of interconnected pixels, and one or more processors 110 may remove, from an image, speckle regions each having a size that is below a specified threshold. The technique of removing speckle regions from an image is referred to as speckle filtering.

To determine the size of a speckle region, one or more processors 110 may determine whether adjacent pixels in an image belong to the same speckle region by determining a connection between the adjacent pixels. One or more processors 110 may determine the connection between two adjacent pixels based on determining the difference between the motion vectors of the two pixels. A small difference between the motion vectors may be indicative of a connection between the two pixels, while a large difference may be indicative of a disconnection between the two pixels. For example, one or more processors 110 may determine that two adjacent pixels belong to the same speckle region if the difference between the motion vectors of the two pixels is equal to or below a specified threshold, and may determine that two adjacent pixels do not belong to the same speckle region if the difference between the motion vectors of the two pixels is larger than the specified threshold.

In accordance with aspects of this disclosure, one or more processors 110 may identify one or more speckles within an image and may process the image to remove the one or more speckles from the image. To identify one or more speckles in an image, one or more processors 110 may determine, for each of a plurality of pixels in the image, a speckle size associated with the pixel. The plurality of pixels in the image may, in some examples, be every pixel of the image. One or more processors 110 may determine, for each of the plurality of pixels in the image, a confidence level of the pixel based on the speckle size of the pixel. One or more processors 110 may determine whether to remove the speckle from the pixel based on the confidence level of the pixel. If one or more processors 110 determines to remove the speckle from the pixel, one or more processors 110 may remove the speckle from the pixel, such as by changing the pixel values of the pixel in order to remove noise from the pixel of the image.

One or more processors 110 may determine, for each of a plurality of pixels in the image and in raster scan order, a speckle size associated with the pixel. One or more processors 110 may determine a speckle size associated with a pixel, referred to herein as a subject pixel, based on a window associated with the pixel.

A window associated with a subject pixel may be a portion of the image (i.e., fewer than all of the pixels of the image) that centers on the subject pixel. That is, the window may include the subject pixel in the center of the window and may also include a plurality of neighboring pixels in a neighborhood of the subject pixel. A window associated with a subject pixel may be a rectangular block of pixels. Example dimensions of a window may be 7×15, 11×11, 17×33, or any other suitable dimension of a rectangular block of pixels.

To determine a speckle size associated with a subject pixel using an associated window, one or more processors 110 may determine, for each column of a plurality of columns in the window, one or more partial speckle regions in the column. One or more processors 110 may determine, for each pixel in the column, whether the pixel is connected to an adjacent pixel based on motion vector values associated with the pixel and the adjacent pixel.

One or more processors 110 may determine, for each pixel in an image, a corresponding motion vector value. In general, one or more processors 110 may, based on movement of objects detected between images of the objects, determine motion vector values of pixels in the image associate with the objects. Any other suitable technique may also be used to determine, for each pixel in an image, a corresponding motion vector value.

One or more processors 110 may determine, for pairs of adjacent pixels in a column, differences between the motion vector values associated with the pair of pixels to determine whether the two pixels are connected. A small difference between the motion vectors may be indicative of a connection between the two pixels, while a large difference may be indicative of a disconnection between the two pixels. For example, one or more processors 110 may determine that two adjacent pixels are connected if the difference between the motion vectors of the two pixels is equal to or below a specified threshold, and may determine that two adjacent pixels are not connected if the difference between the motion vectors of the two pixels is larger than the specified threshold.

One or more processors 110 may also determine that more than two pixels in a column can be connected. For example, if one or more processors 110 determines that two or more pixels are connected in a column, any other pixel in the column adjacent to one of the two or more pixels can also be connected to the connected two or more pixels if the difference in motion vector values between an adjacent pixel and one of the two or more pixels is equal to or below a specified threshold.

One or more processors 110 may therefore determine, for a column, that each two or more connected pixels in the column is a partial speckle region. One or more processors 110 may also determine, for the column, that any pixel in the column not connected to any other adjacent pixels in the column is also a partial speckle region. In this way, one or more processors 110 may determine, for a column in the window, one or more partial speckle regions, and may, for each respective column of the window, the one or more partial speckle regions in the respective column.

One or more processors 110 may determine a speckle size for a subject pixel based on the determined one or more partial speckle regions for each column of the plurality of columns in the window. One or more processors 110 may determine, based on the one or more partial speckle regions for each of the plurality of columns, connections of pixels within columns of the window and between columns of the window to determine a plurality of speckle regions in the window.

Each speckle region in the window may be a connected set of pixels in the column that are connected based on the corresponding motion vector values of the pixels, similar to the partial speckle regions in the columns of the window. Further, one or more of the speckle regions may each connect pixels across multiple columns of the window.

One or more processors 110 may determine the speckle size for the subject pixel based on the number of pixels in the speckle region that includes the subject pixel. For example, the speckle size for the subject pixel may be the count of the number of pixels in the speckle region that includes the subject pixel.

One or more processors 110 may determine, based on the speckle size for the subject pixel, to remove noise from the subject pixel from the image. For example, one or more processors 110 may generate a confidence map for the image based on the speckle size of each of the pixels of the image. One or more processors 110 may, for each pixel in the image, determine a corresponding confidence level based on the speckle size of the pixel. One or more processors 110 may determine a confidence level of a pixel that corresponds with the speckle size of the pixel. A low confidence level of a pixel may be indicative of the pixel being noise that should be removed from the image, and a high confidence level of a pixel may be indicative of the pixel not being noise.

One or more processors 110 may determine, for each pixel of the image, a confidence level of the pixel based on the speckle size of the pixel, and may compare the confidence level of the pixel with a confidence threshold to determine whether to remove noise from the pixel from the image. If one or more processors 110 determines that the confidence level of a pixel is less than the confidence threshold, one or more processors 110 may determine to remove noise from the pixel from the image

One or more processors 110 may, based on determining to remove noise from a pixel from the image, remove the noise from the pixel from the image. Removing noise from a pixel from the image may include changing the pixel value (e.g., a color value) of the pixel. For example, one or more processors 110 may perform filtering techniques, such as mean filtering, median filtering, gaussian filtering, bilateral filtering, and the like to update the pixel value of the pixel, such as based on the pixel values of neighboring pixels of the image, to remove noise from a portion of a speckle region represented by the pixel from the image.

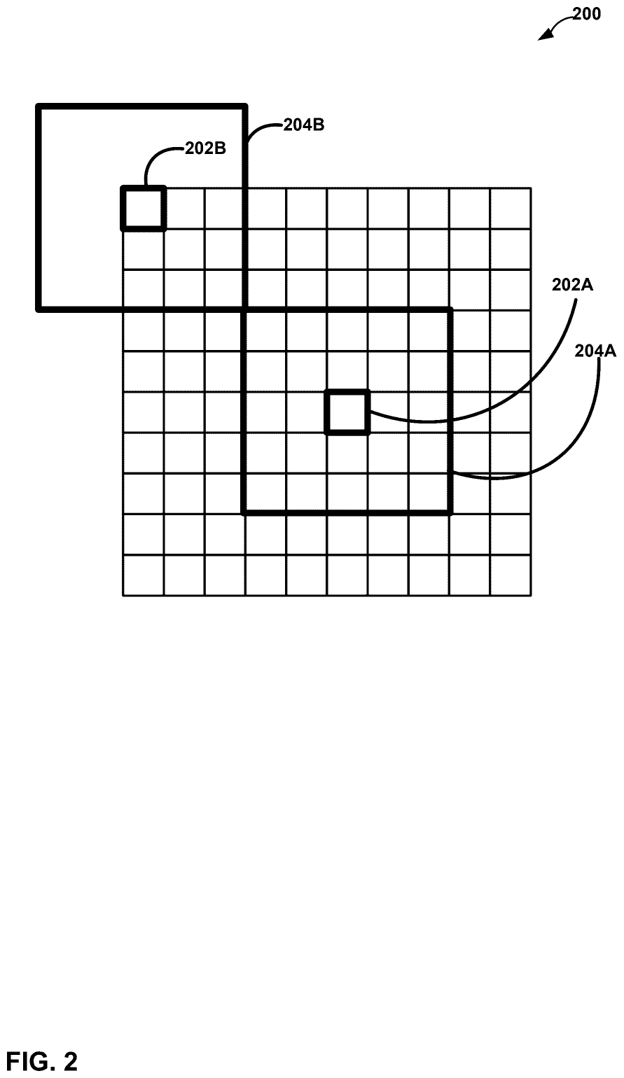

FIG. 2 illustrates an example image for which speckle sizes of pixels can be determined, in accordance with the techniques of this disclosure. FIG. 2 is described with respect to FIG. 1.

As shown in FIG. 2, image 200 may be a portion of an image frame (e.g., a camera frame captured by camera 102) that comprises an array pixels. One or more processors 110 may determine, for each pixel in image 200, a corresponding speckle size of the pixel. Processor 110 may process pixels in image 200 in raster scan order to determine, for each pixel, a corresponding speckle size of the pixel. That is, processor 110 may start processing pixels of the top row of image 200 from left to right. After determining the speckle sizes of each of the pixels in the top row of image 200, processor 110 may process the next row of pixels of image 200 from left to right, and so on, to determine, for each pixel in image 200, a corresponding speckle size of the pixel.

One or more processors 110 may determine a speckle size of a pixel (referred to herein as a subject pixel) based on a window associated with the subject pixel. The window may be centered on the subject pixel. That is, the window may include the subject pixel as the center pixel of the window. A window for a subject pixel may have a particular dimension, such as 15×15, 11×17, and the like. That is, a window having a dimension of 15×15 may encompass a block of pixels having a width of 15 pixels and a height of 15 pixels. One or more processors 110 may use windows having the same dimensions to determine, for each pixel of image 200, the speckle size of the pixel.

In the example of FIG. 2, one or more processors 110 may determine a speckle size of subject pixel 202A based on window 204A that is a 5×5 window centered on subject pixel 202A. As can be seen, window 204A encompasses a 5×5 block of pixels and includes subject pixel 202A in the center of window 204A.

In cases where a subject pixel is on or near an edge of image 200, the window associated with the subject pixel may extend beyond the boundaries of image 200 so that the subject pixel remains centered in the window. For example, subject pixel 202B may be associated with window 204B that extends beyond the boundaries of image 200. As can be seen, window 204B, like window 204A, is a 5×5 window. To keep subject pixel 202B centered in window 204B that is a 5×5 window, window 204B only includes nine pixels of image 200. The other sixteen pixels in window 204B are outside the boundaries of image 200 are not used by one or more processors 110 to determine the speckle size of subject pixel 202B.

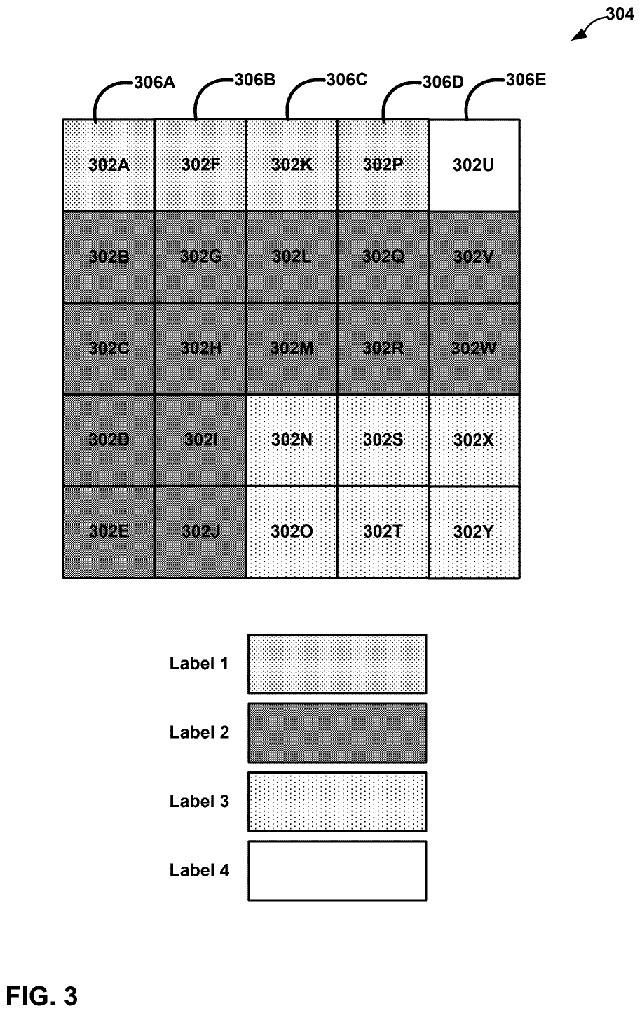

FIG. 3 illustrates an example technique for determining the speckle size of a subject pixel based on an associated window centered on the subject pixel, in accordance with aspects of this disclosure. FIG. 3 is described with respect to FIGS. 1 and 2.

As shown in FIG. 3, window 304 is a block of pixels 302A-302Y (collectively “pixels 302”) centered on subject pixel 302M. Window 304 may be a portion of an image frame, such as image 200 shown in FIG. 2, containing a block of pixels 302 of the image that includes subject pixel 302M at the center of window 304. In the example of FIG. 3, window 304 is a 5×5 block of pixels that is centered on subject pixel 302M.

One or more processors 110 may determine, based on window 304 associated with subject pixel 302M, a speckle size of subject pixel 302M. The speckle size of subject pixel 302M may be the size of a speckle region (i.e., the number of pixels 302 that are in the speckle region) within window 304 that includes subject pixel 302M.

Window 304 includes columns 306A-306E (collectively “columns 306”). In the example of FIG. 3, where window 304 is a 5×5 window, window 304 includes five columns 306. Each column of columns 306 includes an entire column of pixels in window 304. For example, column 306A includes pixels 302A-302E, column 306B includes pixels 302F-302J, column 36C includes pixels 302K-302O, column 306D includes pixels 302P-302T, and column 306E includes pixels 302U-302Y.

As described above, one or more processors 110 may determine whether two adjacent pixels are connected, such that the two adjacent pixels are in the same partial speckle region, based on comparing motion vector values of the two adjacent pixels. If one or more processors 110 determines that the difference between the motion vector values of two adjacent pixels is below a specified threshold, one or more processors 110 may determine that the two pixels are connected, such that the two pixels are in the same partial speckle region. Further, if one or more processors 110 determines that a pixel is not connected to any of its adjacent pixels, one or more processors 110 may also determine that the pixel forms its own partial speckle region.

One or more processors 110 may determine, for each column of the plurality of columns 306 in window 304, one or more partial speckle regions. That is, one or more processors 110 may determine, for each column the number of partial speckle regions within the column that are formed by the pixels of the column. One or more processors 110 may determine, for column 306A, one or more partial speckle regions formed by for pixels 302A-302E. One or more processors 110 may, starting with the top pixel 302A of column 306A, determine whether pixel 302A is connected to adjacent pixel 302B. Because pixel 302B is the only pixel in column 306A adjacent to pixel 302A, one or more processors 110 may determine, based on pixel 302A is not connected to pixel 302B, that 302A forms a first partial speckle region in column 306A.

One or more processors 110 may also determine whether pixel 302B is connected to adjacent pixel 302C in column 306A and may, based on determining that pixel 302B is connected to adjacent pixel 302C in column 306A, determine that pixels 302B and 302C together form a second partial speckle region in column 306A. One or more processors 110 may also determine whether pixel 302C is connected to adjacent pixel 302D in column 306A and may, based on determining that pixel 302C is connected to adjacent pixel 302D in column 306A, update the second partial speckle region in column 306A to include pixels 302B-302D. Similarly, one or more processors 110 may also determine whether pixel 302D is connected to adjacent pixel 302E in column 306A and may, based on determining that pixel 302D is connected to adjacent pixel 302E in column 306A, update the second partial speckle region in column 306A to include pixels 302B-302E. In this way, one or more processors 1110 determines that column 306A includes two partial speckle regions: a first partial speckle region formed by pixel 302A and a second partial speckle region formed by pixels 302B-302E.

One or more processors 110 may, as part of determining the one or more partial speckle regions within column 306A, label each pixel in column 306A with a label indicative of the partial speckle region to which the pixel belongs. One or more processors 110 may label pixel 302A with a first label to indicate that pixel 302A is in a first partial speckle region and may label each of pixels 302B-302E with a second label to indicate that pixels 302B-302E are in a second speckle region.

One or more processors 110 may track the number of pixels in window 304 that are labeled by each of a plurality of labels in window 304. As part of determining one or more partial speckle regions in column 306A, one or more processors 110 may track the number of pixels in column 306A that are labeled by each of a plurality of labels. One or more processors 110 may therefore determine that one label is labeled with the first label and four pixels are labeled with the second label.

One or more processors 110 may determine, based on the one or more partial speckle regions in column 306A, a connection map that indicates connections between pixels 302 within window 304 to form the partial speckle regions within window 304. One or more processors 110 may, based on processing pixels 302A-302E of column 306A, determine a connection map that indicates pixel 302A is unconnected to any other pixel in column 306A and that pixels 302B-302E are all connected.

One or more processors 110 may determine, for column 306B, one or more partial speckle regions formed by pixels 302F-302J in column 306B. One or more processors 110 may, starting with the top pixel 302F of column 306B, determine that pixel 302F is not connected to adjacent pixel 302G of column 306B. Because pixel 302A that is in column 306A has already been labeled with first label, one or more processors 110 may determine whether pixel 302F connects to adjacent pixel 302A (e.g., based on a difference in motion vector values between pixels 302F and 302A). One or more processors 110 may determine that pixel 302F is connected to pixel 302A and may therefore label pixel 302F with the same first label as pixel 302A. That is, one or more processors 110 may determine that pixels 302A and 302F form a partial speckle region.

One or more processors 110 may also determine, similar to pixels 302B-302E of column 306A, that pixels 302G-302J of column 306B are connected and thus form a partial speckle region in column 306B. One or more processors 110 may also compare motion vector values of one or more of pixels 302G-302J of column 306B with an adjacent pixel of pixels 302B-302E of column 306A and may determine that pixels 302G-302J of column 306B are connected to pixels 302B-302E to form a partial speckle region. One or more processors 110 may therefore label each of pixels 302G-302J with the same first label as pixels 302B-302E to indicate that pixels 302B-302E and pixels 302G-302J form a partial speckle region.

One or more processors 110 may, as part of determining the one or more partial speckle regions in column 306B, track the number of pixels in column 306B that are labeled by each of a plurality of labels and may, based on also tracking the number of pixels in column 306A that are labeled by each of a plurality of labels, track the number of pixels in columns 306A-306B that are labeled by each of a plurality of labels. For example, one or more processors 110 may determine that there are two pixels, pixels 302A and 302F, that are labeled with first label in columns 306A-306B and that there are eight pixels, pixels 302B-302E and pixels 302G-302J, that are labeled with second label in columns 306A and 306B.

One or more processors 110 may, as part of determining the one or more partial speckle regions in column 306B, also update the connections map that was determined based on determining the one or more partial speckle regions in column 306B. One or more processors 110 may update the connection map to also indicates connections between pixels 302F-302J as well as any connections between pixels in column 306B with pixels in column 306A. For example, one or more processors 110 may update the connection map to indicate that pixel 302F of column 306B is connected to pixel 302A of column 306A, and may also update the connection map to indicate that pixels 302G-302J of column 306B are connected together and are also connected to pixels 302B-302E of column 306A.

One or more processors 110 may determine, for column 306C, one or more partial speckle regions formed by pixels 302K-302O in column 306C. One or more processors 110 may, starting with the top pixel 302K of column 306C, determine that pixel 302K is not connected to adjacent pixel 302L of column 306C. Because pixel 302F that is in column 306B has already been labeled with first label, one or more processors 110 may determine whether pixel 302K connects to adjacent pixel 302F (e.g., based on a difference in motion vector values between pixels 302F and 302K). One or more processors 110 may determine that pixel 302K is connected to pixel 302F and may therefore label pixel 302F with the same first label as pixel 302F. That is, because pixels 302A and 302F already form a partial speckle region, one or more processors 110 may update the partial speckle region by determining that pixels 302A, 302F, and 302K form a partial speckle region.

One or more processors 110 may also determine, based on comparing motion vector values, that pixels 302L and 302M of column 306C are connected and thus form a partial speckle region in column 306C. One or more processors 110 may also compare motion vector values of one or more of pixels 302L-302M of column 306C with an adjacent pixel of pixels 302G-302H of column 306B and may determine that pixels 302L-302M of column 306B are connected to pixels 302G-302H of column 306B. Because pixels 302G-302H are each labeled with second label, one or more processors 110 may also label each of pixels 302L-302M with the same second label.

One or more processors 110 may also determine, based on comparing motion vector values, that pixel 302N of column 306C is not connected to pixel 302M but is connected to pixel 302O. One or more processors 110 may therefore determine that pixels 302M and 302O form a partial speckle region and may label each of pixels 302N and 302O with a third label.

One or more processors 110 may, as part of determining the one or more partial speckle regions in column 306B, track the number of pixels in column 306C that are labeled by each of a plurality of labels and may, based on also tracking the number of pixels in columns 306A-306B that are labeled by each of a plurality of labels, track the number of pixels in columns 306A-306C that are labeled by each of a plurality of labels. For example, one or more processors 110 may determine that there are three pixels, pixels 302A, 302F, and 302K, that are labeled with first label in columns 306A-306C, that there are ten pixels, pixels 302B-302E, pixels 302G-302J, and pixels 302L-302M that are labeled with second label in columns 306A-306C, and that there are two pixels, pixels 302N-302O, that are labeled with the third label in columns 306A-306C.

One or more processors 110 may, as part of determining the one or more partial speckle regions in column 306C, also update the connections map based on determining the one or more partial speckle regions in column 306C. One or more processors 110 may update the connection map to also indicates connections between pixels 302K-302O in column 306C as well as any connections between pixels in column 306C with pixels in column 306B. For example, one or more processors 110 may update the connection map to indicate that pixel 302F of column 306B is connected to pixel 302A of column 306A, and may also update the connection map to indicate that pixels 302G-302J of column 306B are connected together and are also connected to pixels 302B-302E of column 306A. One or more processors 110 may also update the connection map to indicate that pixels 302N and 302O of column 306C are connected together in a partial speckle region.

One or more processors 110 may perform techniques similar to those illustrated with respect to columns 306A-306C of window 304 to determine one or more partial speckle regions of each of the remaining columns 306D and 306E. One or more processors 110 may continue to label each of the pixels 302P-302T and 302U-302Y of columns 306D and 306E, respectively and track the number of pixels in each of column 306D and 306E that are labeled by each of a plurality of labels.

One or more processors 110 may, in this way, be able to label each pixel of window 304 with a corresponding label of a plurality of labels and may be able to determine, for each respective label, a count of the number of pixels labeled with the respective label. In the example of FIG. 3, one or more processors 110 may determine that, as an end result, window 304 includes four pixels that are labeled with the first label, fourteen pixels that are labeled with the second label, six pixels that are labeled with the third label, and one pixel that is labeled with the fourth label.

One or more processors 110 may also continue updating the connection map based on determining one or more partial speckle regions of each of the remaining columns 306D and 306E to generate the connection map that indicates the connections of each of the pixels in window 304. In the example of FIG. 3, the connection map may indicate that pixels 302A, 302F, 302K, and 302P are connected to form a first speckle region in columns 306, that pixels 302B-302E, 302G-302J, 302L-302M, 302Q-302R, and 302V-302W are connected to form a second speckle region in window 304, that pixels 302N-302O, 302S-302T, and 302X-302Y are connected to form a third speckle region in window 304, and that pixel 302U is a fourth speckle region in window 304.

One or more processors 110 may determine the speckle size of subject pixel 302M as the number of pixels in the same speckle region in window 304 as subject pixel 302M. One or more processors 110 may determine the number of pixels in the same speckle region in window 304 as subject pixel 302M based on the count of the number of pixels labeled with the same label as subject pixel 302M and the connection map for window 304. For example, one or more processors 110 may determine that there are fourteen pixels labeled with the same label as subject pixel 302M in window 304 and may determine, based on the connection map, that all fourteen pixels are connected. Thus, one or more processors 110 may determine the speckle size of subject pixel 302M to be fourteen.

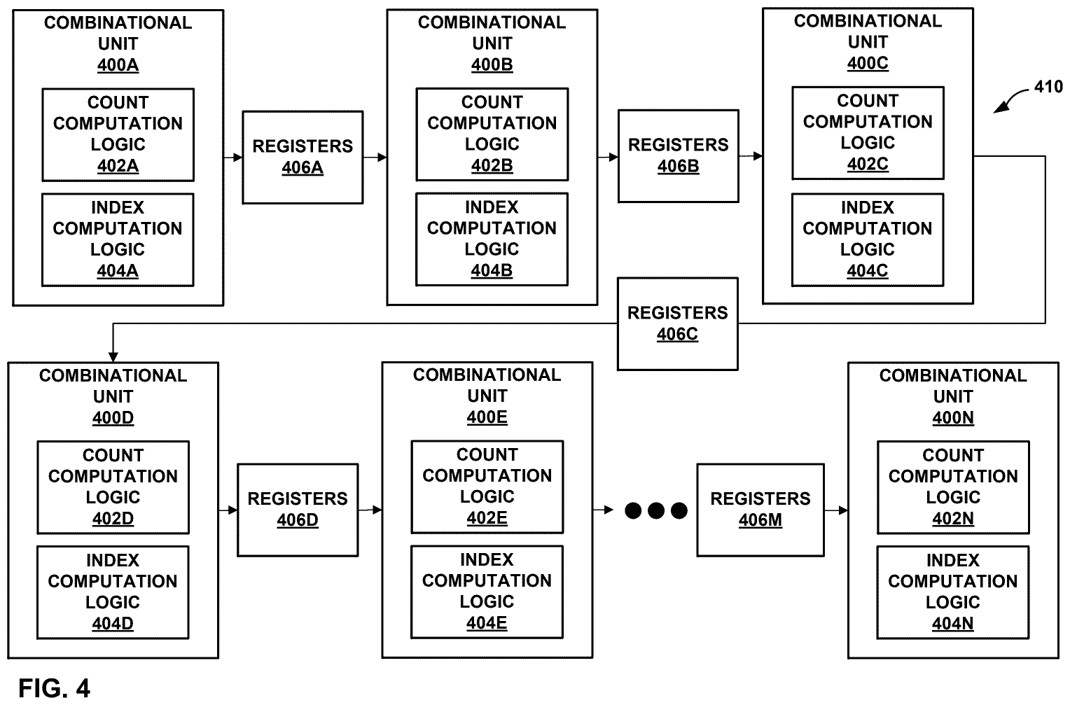

FIG. 4 is a block diagram illustrating example hardware units of processing circuitry configured to determine speckle sizes of pixels, in accordance with the techniques of this disclosure. FIG. 4 is described with respect to FIGS. 1-3.

As shown in FIG. 4, one or more processors 410, which may be an example of one or more processors 110 of FIG. 1, may implement or otherwise include combinational units 400A-440N (collectively “combinational units 400”). Registers 406A-406M (collectively “registers 406”) between combinational units 400 enable data to be transmitted between pairs of combinational units 400.

Combinational units 400 are arranged sequentially, so that a first combinational unit (e.g., combinational unit 400A) communicates with the second combinational unit (e.g., combinational unit 400B) in the sequence, and the second combinational unit (e.g., combinational unit 400B) in the sequence communicates with the third combinational unit (e.g., combinational unit 400B) in sequence. A combinational unit may communicate with the next combinational unit by writing data to a register between the two sequential combinational units, and the next combinational unit may read out the data from the register. For example, combinational unit 400A may write data to registers 406A that combinational unit 400B may read out, combinational unit 400B may write data to registers 406B that combinational unit 400C may read out, and so on.

Each combinational unit of combinational units 400 may be implemented in hardware, such as logic circuitry, to determine, for a corresponding column of a window (e.g., window 304 of FIG. 4) associated with a subject pixel (e.g., subject pixel 302M of FIG. 3) Each combinational unit may process pixels of a single column in a window. Thus, combinational units 400 may include the same number of combinational units as the number of columns in a window. In the example where a window has five columns (e.g., window 304 having five columns 306 in FIG. 3), combinational units 400 may only include five combinational units 400A-400E that each processes pixels of a corresponding one of the five columns.

Combination units 400 include corresponding count computation logic 402A-402N (collectively “count computation logic 402”) and index computation logic 404A-404N (collectively “index computation logic 404”). Each of count computation logic 402 is configured to calculate the size of speckle regions within a corresponding column, and each of index computation logic 404 is configured to label each pixel within the corresponding column.

A combinational unit processes pixels of a column to label each pixel with a label and to determine the sizes of one or more speckle regions in the column. Each combinational unit may be able to label each pixel of a corresponding column and to determine the sizes of one or more speckle regions in the column in a single clock cycle. Thus, in the example where a window has sixteen columns, combination units 400 may be able to label each pixel in the window and determine the sizes of one or more speckle regions in the window in sixteen columns, and one or more processors 410 may be able to determine the speckle size of the subject in the window in an additional clock cycle.

Each of combinational units 400 may sequentially process (e.g., label) pixels of a corresponding column in order from the pixel at the top of the column down to the pixel at the bottom of the column. For example, to process pixels in window 304, combinational unit 400A may start by processing pixel 302A of column 306A. Combinational unit 400A may then process the next pixel 302B in column 306A, and so on, until combinational unit 400A has processed each pixel of column 306A.

A combinational unit may, upon labeling a pixel in the corresponding column, send labeling information associated with the pixel to the next combinational unit of combinational units 400, such as by storing the labeling information in the registers between the two combinational units. The combinational unit may also, upon counting the sizes of one or more speckle regions in the corresponding column, send such speckle region size information to the next combinational unit of combinational units 400, such as by storing the labeling information in the registers between the two combinational units.

Combinational units 400 may represent the one or more speckle regions in a window in the form of a connection map that specifies the connection of pixels into one or more speckle regions. That is, a connection map for a window may specify, for each pixel in the window, whether the pixel is connected to adjacent pixels (e.g., to the top, left, right, or bottom of the pixel). Combinational units 400 may create a connection map of one or more speckle regions in a first column of a window, update the connection map based on one or more speckle regions determined in the next column of the window, and may continue updating the connection map based on one or more speckle regions determined in subsequent columns of the window, and so on, until combinational units 400 has determined the connection map for the window based on all of the columns of the window.

For example, with reference back to FIG. 3, combinational unit 400A may determine that column 306A includes a first speckle region made up of pixel 302A and a second speckle region made up of pixels 302B-302E and may generate a connection map that indicates the two speckle regions in column 306A. Combinational unit 400A may send the connection map to combinational unit 400B, such as via registers 406A. Combinational unit 400B may determine that column 306B includes pixel 302F that connects to (e.g., is part of) the speckle region made up of pixel 302A in column 306A and may determine that column 306B also includes pixels 302G-302J that connect to the speckle region made up of pixels 302B-302E. Combinational unit 400B may therefore update the connection map to specify a first speckle region that includes pixels 302A and 302F and a second speckle region that includes pixels 302B-303E and pixels 302G-302J. Combinational unit 400B may send the connection map to combinational unit 400C, such as via registers 406B.

Combinational unit 400C may determine that column 306C includes pixel 302K that connects to (e.g., is part of) the speckle region made up of pixels 302A and pixel 302B in columns 306A and 306B and may determine that column 306C also includes pixels 302L-302M that connect to the speckle region made up of pixels 302B-302E and pixels 302G-302J. Combinational unit 400 may also determine that column 306C also includes pixels 302N-302O that form a new speckle region.

Combinational unit 400C may therefore update the connection map to specify a first speckle region that includes pixels 302A, 302F, and 302K, a second speckle region that includes pixels 302B-303E, pixels 302G-302J, and pixels 302L-302M, and a third speckle region that includes pixels 302N-302O. Combinational units 400 may continue to forward the connection map and continue to update the connection map based on the remaining columns 306D and 306E of window 304 to generate a complete connection map that specifies the connection of pixels in window 304 into one or more speckle regions.

As described above, one or more processors 410 may determine a speckle size for each pixel in an image in raster scan order using, for each pixel, an associated window. As such, each of combinational units 400 may, upon finishing labeling the pixels of a corresponding column in a window associated with a subject pixel and counting the sizes of one or more speckle regions in the corresponding column in the window, start processing pixels of a corresponding column in a window associated with a subsequent subject pixel according to the raster scan ordering of pixels of the image.

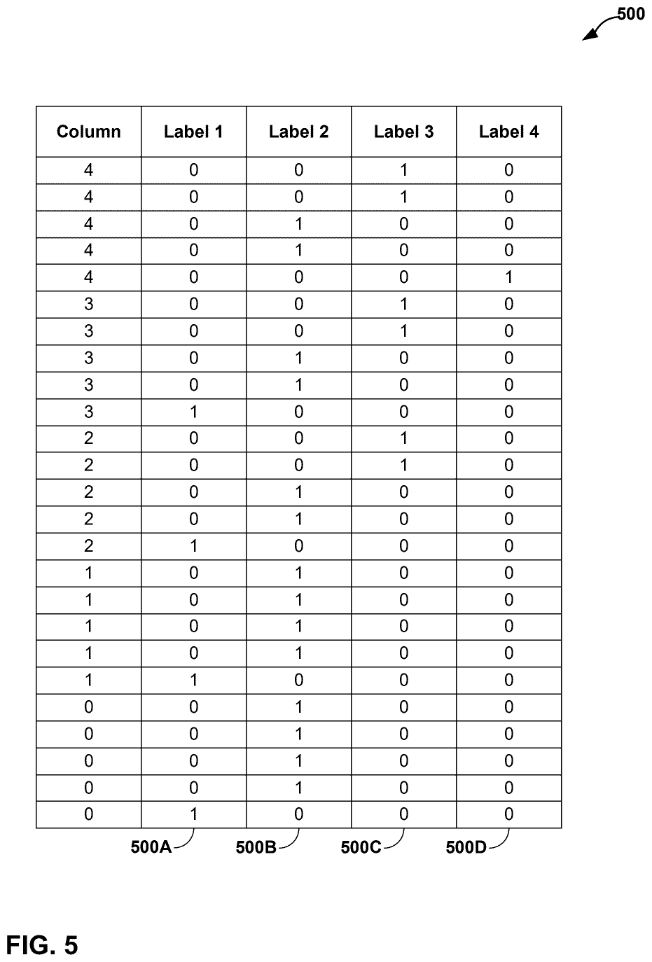

FIG. 5 illustrates bitmasks for encoding labeling information for columns in a window, in accordance with the techniques of this disclosure. FIG. 5 is described with respect to FIGS. 1-4.

One or more processors 110 (e.g., count computation logic 402 of combinational units 400) may generate and update one or more bitmasks to encode labeling information, which one or more processors 110 may use to more efficiently label pixels in a window associated with a subject pixel. One or more processors 110 may generate and update a bitmask for each label in a window that indicate the locations of pixels having that label in the window. One or more processors 110 may use the bitmasks to determine a speckle size for a subject pixel associated with the subject pixel as a sum of the bits in the bitmask for the label of the subject pixel. A combinational unit (e.g., of combinational units 400) that processes (e.g., labels the pixels) a corresponding column of pixels in the image may determine a bitmask for the corresponding column of pixels, and may pass the determined bitmask to a combinational unit that processes a subsequent column of pixels in the image to determine the bitmask for the subsequent column of pixels.

In the example of FIG. 5, bitmasks 500 may include corresponding bitmasks 500A-500D for labels 1-4, respectively in window 304 of FIG. 3 that specify the specific columns 0-4, which correspond to columns 306A-304E, of window 304. Bitmask 500A for label 1 may specify that 1 pixel is labeled with label 1 in each of columns 0, 1, 2, 3, for a total of 4 pixels, and can be encoded as 0x8421h (in hexadecimal).

Bitmask 500B for label 2 may specify that 4 pixels are labeled with label 2 in each of columns 0 and 1 and that 2 pixels are labeled with label 2 in each of columns 3-5 for a total of 14 pixels, and can be encoded as 0x631BDEh. Bitmask 500C for label 3 may specify that 2 pixels are labeled with label 3 in each of columns 2-4 for a total of 6 pixels, and can be encoded as 18C6060h. Bitmask 500D for label 4 may specify that 1 pixel is labeled with label 4 in column 3, and can be encoded as 100000h.

In the example of FIG. 3, the subject pixel 302M associated with window 304 is labeled with label 2. As such, one or more processors 110 may determine the speckle size of subject pixel 302M as the number of pixels in label 4, which is 14.

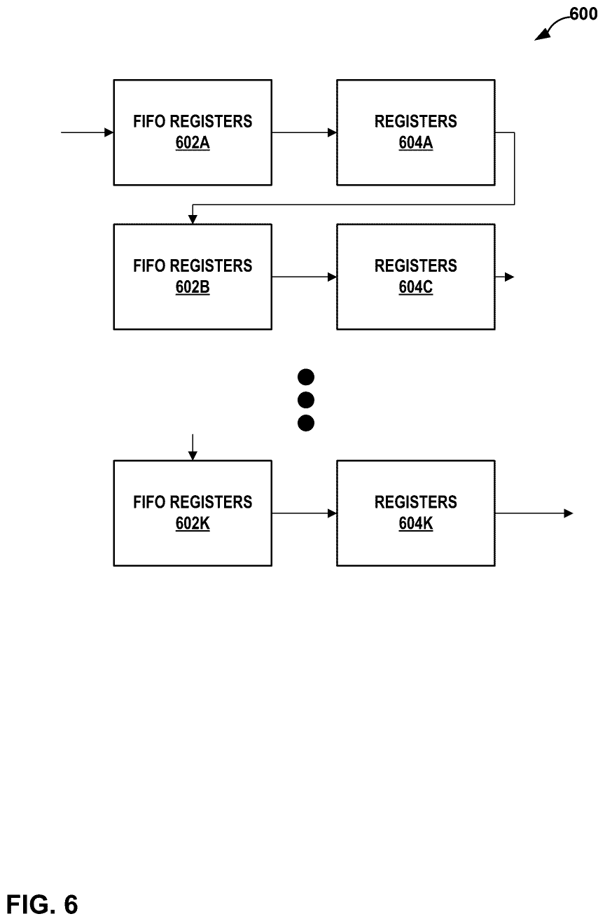

FIG. 6 is a block diagram illustrating example hardware units of processing circuitry configured to store a connection map, in accordance with the techniques of this disclosure. FIG. 6 is described with respect to FIGS. 1-5.

As described above, a connection map for a window may specify, for each pixel in the window, whether the pixel is connected to one or more adjacent pixels. For example, a connection map may specify, for each pixel, whether the pixel is connected to an adjacent pixel above the pixel, an adjacent pixel below the pixel, an adjacent pixel to the right of the pixel, and an adjacent pixel to the left of the pixel.

One or more processors 110 may store, for each pixel in a window, a corresponding element in the connection map that indicate the connections of the pixel to adjacent pixels. One or more processors 110 may provide the elements in raster scan order of the pixels in the window, such as for the purposes of using the connection map to determine the speckle size of the subject pixel in the window. As such, one or more processors 110 may use registers that stores data in a first in, first out (FIFO) manner to store the connection map.

As shown in FIG. 6, one or more processors 110 may include register structure 600 for storing a connection map for a window. Register structure 600 includes FIFO registers 602A-602K (collectively, “FIFO registers 602”), such as shift registers, connected in series with registers 604A-604K (collectively, “registers 604”). Each of FIFO registers 602 stores connection map elements for a corresponding row of pixels in a window and, as such, register structure 600 includes as many FIFO registers 602 as there rows of pixels in a window. For example, for a window (e.g., window 304 of FIG. 3) having five rows of pixels, register structure 600 may include five FIFO registers 602.

One or more processors 110 may sequentially store connection map elements for a row of pixels from left to right into a FIFO register 602, and may be read the connection map elements for the row of pixels in a FIFO fashion, starting from the leftmost pixel in the row, out of the FIFO register into corresponding registers of registers 604. For example, one or more processors 110 may store connection map elements for a first row of pixels of window 304 in order starting from pixel 302A into FIFO register 602A, and may read out the connection map elements for the first row of pixels of window 304 out of FIFO register 602A into registers 604A in order starting from the connection map element for pixel 302A.

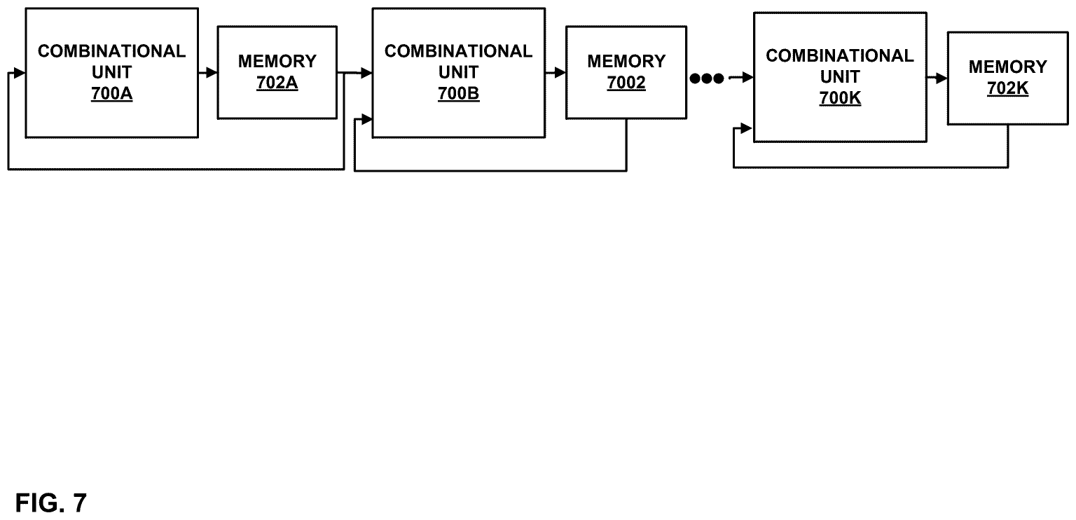

FIG. 7 is a block diagram illustrating example hardware units of processing circuitry configured to determine speckle sizes of pixels, in accordance with the techniques of this disclosure. FIG. 7 is described with respect to FIGS. 1-6.

One or more processors 110 may use single port memory for storing a connection map that is used to determine now pixels are connected within a window. Such single port memory may not be written to and read from at the same time and may therefore provide connection map elements every other clock cycle.

Due to such limitations of single port memory, one or more processors 110 may implement combinational units 700A-700K (collectively “combinational units 700”) that computes the size of speckle regions labels pixels for two successive columns of a window every other clock cycle. Combinational units 700 perform functionality similar to that combinational units 400 in FIG. 4 to determine the size of speckle regions within a column and labels pixels for a column, but may differ from combinational units 400 in that each of combinational units 700 is able to determine the size of speckle regions within a column and labels pixels for a column for each of two successive columns in the window. For example, combinational unit 700A may determine the size of speckle regions within a column and labels pixels for a column for each of a first two columns of a window, combinational unit 700B may determine the size of speckle regions within a column and labels pixels for a successive second two columns of the window, and so on.

Combinational units 700 are connected to respective memories 702A-702K (collectively “memories 702”). A combinational unit of combinational units 700 may determine a connection map based on a column of a window and may store the connection map in a corresponding memory of memories 702. Because a combinational unit is able to determine a connection map for two successive columns of a window, a combinational unit may also read back the connection map for a first column of the two columns from the corresponding memory to update the connection map based on the successive second column of the two columns, and to store the updated connection map into the corresponding memory, which can be read by the next combinational unit in the sequence of combinational units 700.

For example, combinational unit 700A may determine a connection map based on the first column of a window and may store the connection map in memory 702A. Combinational unit 700A may read the connection map from memory 702A to update the connection map based on the second column of the window and may store the updated connection map in memory 702A. Combinational unit 700B may read the connection map generated by combinational unit 700A from memory 702A and may update the connection map based on the third column of the window and may store the updated connection map in memory 702B. Combinational unit 700B may read the connection map from memory 702B to update the connection map based on the fourth column of the window and may store the updated connection map in memory 702B. In this way, combinational units 700 may sequentially update the connection map for the window.

In this way, one or more processors 110 may implement combinational units 700 to perform hardware reutilization by reusing each of combinational units 700 to determine the size of speckle regions and labels pixels for each of two successive columns in a window. Such hardware reutilization may reduce the area of hardware in one or more processors 110 that performs speckle filtering, thereby providing a technical advantage.

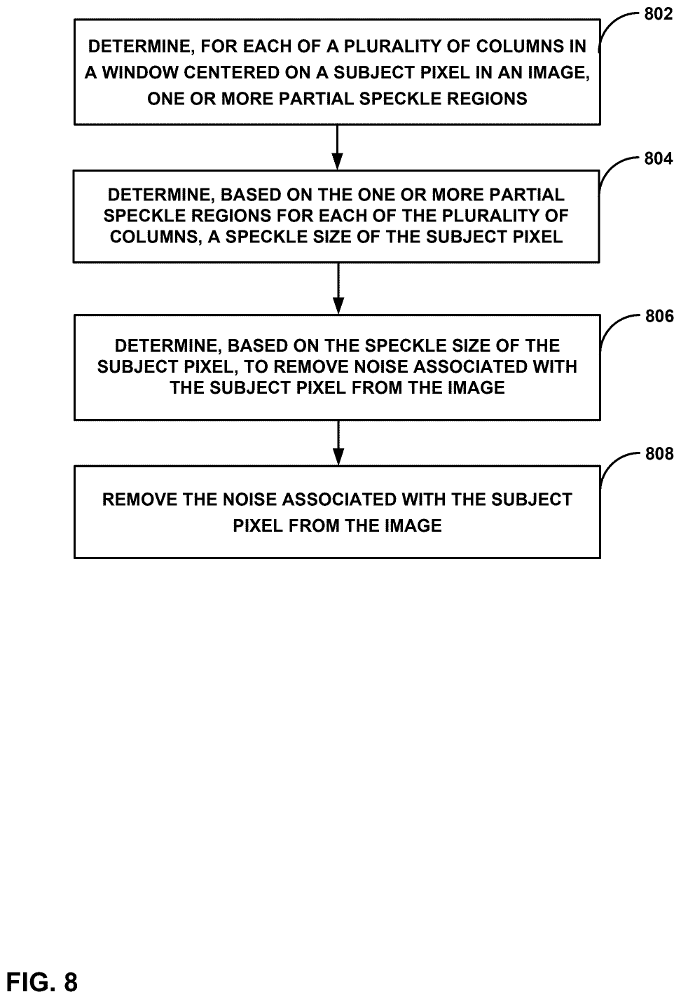

FIG. 8 is a flowchart showing an example method of operation according to the techniques of this disclosure. For ease, the example is described with respect to FIGS. 1-7.

As shown in FIG. 8, one or more processors 110 may determine, for each of a plurality of columns in a window 304 centered on a subject pixel 302M in an image 200, one or more partial speckle regions (802). In some examples, to determine, for each of the plurality of columns in a window 304 associated with a subject pixel 302M in the image 200, one or more partial speckle regions, the one or more processors 110 may label each pixel in the window 304 with a corresponding label of a plurality of labels associated with a plurality of partial speckle regions in the window 304, wherein the corresponding label is indicative of a corresponding partial speckle region out of the plurality of partial speckle regions in the window 304.

In some examples, to label each pixel in the window 304, the one or more processors 110 may label a first pixel in a first column 306A in the window 304 with a first label of the plurality of labels, wherein the first label is indicative of a first partial speckle region, determine whether a second pixel in the first column 306A is part of a same partial speckle region based on comparing respective motion vector values of the first pixel and the second pixel, and based on determining that the second pixel is part of the same partial speckle region as the first pixel, label the second pixel with the first label to indicate that the second pixel is part of the first partial speckle region.

In some examples, to label each pixel in the window 304, the one or more processors 110 may label a first pixel in a first column 306A in the window 304 with a first label of the plurality of labels, determine whether a second pixel in the first column 306A is part of a same partial speckle region based on comparing respective motion vector values of the first pixel and the second pixel, and based on determining that the second pixel is not part of the same partial speckle region as the first pixel, label the second pixel with a second label of the plurality of labels to indicate that the second pixel is part of a second partial speckle region that is different from the partial speckle region.

In some examples, the one or more processors 110 may determine whether a third pixel in a second column 306B adjacent to the first pixel in the first column 306A is part of a same partial speckle region based on comparing respective motion vector values of the first pixel and the third pixel. One or more processors 110 may, based on determining that the third pixel is part of the same partial speckle region as the first pixel, label the third pixel with the first label to indicate that the third pixel is part of a first partial speckle region with the first pixel in the first column 306A.

In some examples, to determine that the third pixel is part of the same partial speckle region as the first pixel the one or more processors 110 may use a connection map that indicates one or more connections between pixels of the image to determine that the third pixel is part of the same partial speckle region as the first pixel.

In some examples, to label each pixel in the window 304, the one or more processors may generate, for each respective label of the plurality of labels, a corresponding bitmask that indicates locations of a corresponding one or more pixels labeled with the respective label.

In some examples, to determine, based on the one or more partial speckle regions for each of the plurality of columns 306, the speckle size of the subject pixel 302M, the one or more processors 110 may determine, based on a count of pixels in the window 304 having a same label as the subject pixel 302M, the speckle size of the subject pixel 302M.

One or more processors 110 may determine, based on the one or more partial speckle regions for each of the plurality of columns 306, a speckle size of the subject pixel 302M (804).

One or more processors 110 may determine, based on the speckle size of the subject pixel, to remove noise associated with the subject pixel from the image (806).

One or more processors 110 may remove the noise associated with the subject pixel from the image (808).

In some examples, the one or more processors 110 include a plurality of hardware units 400 each configured to determine the one or more partial speckle regions in a corresponding column in the window 304. In some examples, each of the plurality of hardware units 400 is configured to determine the one or more partial speckle regions in a corresponding column in the window 304 in a single clock cycle.

The following describes other example aspects of the disclosure. The techniques of the following aspects may be used separately or in any combination.

Clause 1. A computing device comprising: one or more memories configured to store an image; and one or more processors implemented in circuitry, coupled to the one or more memories, and configured to: determine, for each of a plurality of columns in a window centered on a subject pixel in the image, one or more partial speckle regions; determine, based on the one or more partial speckle regions for each of the plurality of columns, a speckle size of the subject pixel; determine, based on the speckle size of the subject pixel, to remove noise associated with the subject pixel from the image; and remove the noise associated with the subject pixel from the image.

Clause 2. The computing device of clause 1, wherein to determine, for each of the plurality of columns in a window associated with a subject pixel in the image, one or more partial speckle regions, the one or more processors are further configured to: label each pixel in the window with a corresponding label of a plurality of labels associated with a plurality of partial speckle regions in the window, wherein the corresponding label is indicative of a corresponding partial speckle region out of the plurality of partial speckle regions in the window.

Clause 3. The computing device of clause 2, wherein to label each pixel in the window, the one or more processors are further configured to: label a first pixel in a first column in the window with a first label of the plurality of labels, wherein the first label is indicative of a first partial speckle region; determine whether a second pixel in the first column is part of a same partial speckle region based on comparing respective motion vector values of the first pixel and the second pixel; and based on determining that the second pixel is part of the same partial speckle region as the first pixel, label the second pixel with the first label to indicate that the second pixel is part of the first partial speckle region.

Clause 4. The computing device of any of clauses 2 and 3, wherein to label each pixel in the window, the one or more processors are further configured to: label a first pixel in a first column in the window with a first label of the plurality of labels; determine whether a second pixel in the first column is part of a same partial speckle region based on comparing respective motion vector values of the first pixel and the second pixel; and based on determining that the second pixel is not part of the same partial speckle region as the first pixel, label the second pixel with a second label of the plurality of labels to indicate that the second pixel is part of a second partial speckle region that is different from the partial speckle region.

Clause 5. The computing device of clause 4, wherein the one or more processors are further configured to: determine whether a third pixel in a second column adjacent to the first pixel in the first column is part of a same partial speckle region based on comparing respective motion vector values of the first pixel and the third pixel; and based on determining that the third pixel is part of the same partial speckle region as the first pixel, label the third pixel with the first label to indicate that the third pixel is part of a first partial speckle region with the first pixel in the first column.

Clause 6. The computing device of clause 5, wherein to determine whether the third pixel in the second column is part of the same partial speckle region, the one or more processors are further configured to: determine, based on a connection map that indicates one or more connections between pixels of the image, that the third pixel in the second column is part of the same partial speckle region.

Clause 7. The computing device of any of clauses 2-6, wherein to label each pixel in the window, the one or more processors are further configured to: generate, for each respective label of the plurality of labels, a corresponding bitmask that indicates locations of a corresponding one or more pixels labeled with the respective label.

Clause 8. The computing device of any of clauses 2-7, wherein to determine, based on the one or more partial speckle regions for each of the plurality of columns, the speckle size of the subject pixel, the one or more processors are further configured to: determine, based on a count of pixels in the window having a same label as the subject pixel, the speckle size of the subject pixel.

Clause 9. The computing device of any of clauses 1-8, wherein the one or more processors include a plurality of hardware units each configured to determine the one or more partial speckle regions in a corresponding column in the window.

Clause 10. The computing device of any of clauses 1-9, wherein each of the plurality of hardware units is configured to determine the one or more partial speckle regions in a corresponding column in the window in a single clock cycle.

Clause 11. A method comprising: determining, with one or more processors and for each of a plurality of columns in a window centered on a subject pixel in an image, one or more partial speckle regions; determining, with the one or more processors and based on the one or more partial speckle regions for each of the plurality of columns, a speckle size of the subject pixel; determining, with the one or more processors and based on the speckle size of the subject pixel, to remove noise associated with the subject pixel from the image; and removing, with the one or more processors, the noise associated with the subject pixel from the image.

Clause 12. The method of clause 11, wherein to determining, for each of the plurality of columns in a window associated with a subject pixel in the image, one or more partial speckle regions further comprises: labeling, with the one or more processors, each pixel in the window with a corresponding label of a plurality of labels associated with a plurality of partial speckle regions in the window, wherein the corresponding label is indicative of a corresponding partial speckle region out of the plurality of partial speckle regions in the window.

Clause 13. The method of clause 12, wherein labeling each pixel in the window further comprises: labeling, with the one or more processors, a first pixel in a first column in the window with a first label of the plurality of labels, wherein the first label is indicative of a first partial speckle region; determining, with the one or more processors, whether a second pixel in the first column is part of a same partial speckle region based on comparing respective motion vector values of the first pixel and the second pixel; and based on determining that the second pixel is part of the same partial speckle region as the first pixel, labeling, with the one or more processors, the second pixel with the first label to indicate that the second pixel is part of the first partial speckle region.

Clause 14. The method of any of clauses 12 and 13, wherein labeling each pixel in the window further comprises: labeling, with the one or more processors, a first pixel in a first column in the window with a first label of the plurality of labels; determining, with the one or more processors, whether a second pixel in the first column is part of a same partial speckle region based on comparing respective motion vector values of the first pixel and the second pixel; and based on determining that the second pixel is not part of the same partial speckle region as the first pixel, labeling, with the one or more processors, the second pixel with a second label of the plurality of labels to indicate that the second pixel is part of a second partial speckle region that is different from the partial speckle region.

Clause 15. The method of clause 14, further comprising: determining, with the one or more processors, whether a third pixel in a second column adjacent to the first pixel in the first column is part of a same partial speckle region based on comparing respective motion vector values of the first pixel and the third pixel; and based on determining that the third pixel is part of the same partial speckle region as the first pixel, labeling, with the one or more processors, the third pixel with the first label to indicate that the third pixel is part of a first partial speckle region with the first pixel in the first column.

Clause 16. The method of clause 15, wherein determining whether the third pixel in the second column is part of the same partial speckle region further comprises: determining, with the one or more processors and based on a connection map that indicates one or more connections between pixels of the image, that the third pixel in the second column is part of the same speckle region.

Clause 17. The method of any of clauses 12-16, wherein labeling each pixel in the window further comprises: generating, with the one or more processors and for each respective label of the plurality of labels, a corresponding bitmask that indicates locations of a corresponding one or more pixels labeled with the respective label.

Clause 18. The method of any of clauses 12-17, wherein determining, based on the one or more partial speckle regions for each of the plurality of columns, the speckle size of the subject pixel further comprises: determining, with the one or more processors and based on a count of pixels in the window having a same label as the subject pixel, the speckle size of the subject pixel.

Clause 19. The method of any of clauses 11-18, wherein the one or more processors include a plurality of hardware units each configured to determine the one or more partial speckle regions in a corresponding column in the window.

Clause 20. A computer-readable storage medium storing instructions thereon that when executed cause one or more processors to: determine, for each of a plurality of columns in a window centered on a subject pixel in an image, one or more partial speckle regions; determine, based on the one or more partial speckle regions for each of the plurality of columns, a speckle size of the subject pixel; determine, based on the speckle size of the subject pixel, to remove noise associated with the subject pixel from the image; and remove the noise associated with the subject pixel from the image.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A computing device comprising:
one or more memories configured to store an image; and
one or more processors implemented in circuitry, coupled to the one or more memories, and configured to:
determine, for each of a plurality of columns in a window centered on a subject pixel in the image, one or more partial speckle regions;
determine, based on the one or more partial speckle regions for each of the plurality of columns, a speckle size of the subject pixel;
determine, based on the speckle size of the subject pixel, to remove noise associated with the subject pixel from the image; and
remove the noise associated with the subject pixel from the image.

2. The computing device of claim 1, wherein to determine, for each of the plurality of columns in a window associated with a subject pixel in the image, one or more partial speckle regions, the one or more processors are further configured to:
label each pixel in the window with a corresponding label of a plurality of labels associated with a plurality of partial speckle regions in the window, wherein the corresponding label is indicative of a corresponding partial speckle region out of the plurality of partial speckle regions in the window.

3. The computing device of claim 2, wherein to label each pixel in the window, the one or more processors are further configured to:
label a first pixel in a first column in the window with a first label of the plurality of labels, wherein the first label is indicative of a first partial speckle region;
determine whether a second pixel in the first column is part of a same partial speckle region based on comparing respective motion vector values of the first pixel and the second pixel; and
based on determining that the second pixel is part of the same partial speckle region as the first pixel, label the second pixel with the first label to indicate that the second pixel is part of the first partial speckle region.

4. The computing device of claim 2, wherein to label each pixel in the window, the one or more processors are further configured to:
label a first pixel in a first column in the window with a first label of the plurality of labels;
determine whether a second pixel in the first column is part of a same partial speckle region based on comparing respective motion vector values of the first pixel and the second pixel; and
based on determining that the second pixel is not part of the same partial speckle region as the first pixel, label the second pixel with a second label of the plurality of labels to indicate that the second pixel is part of a second partial speckle region that is different from a first partial speckle region that includes the first pixel.

5. The computing device of claim 4, wherein the one or more processors are further configured to:
determine whether a third pixel in a second column adjacent to the first pixel in the first column is part of a same partial speckle region based on comparing respective motion vector values of the first pixel and the third pixel; and
based on determining that the third pixel is part of the same partial speckle region as the first pixel, label the third pixel with the first label to indicate that the third pixel is part of the first partial speckle region with the first pixel in the first column.

6. The computing device of claim 5, wherein to determine whether the third pixel in the second column is part of the same partial speckle region, the one or more processors are further configured to:
determine, based on a connection map that indicates one or more connections between pixels of the image, that the third pixel in the second column is part of the same partial speckle region.

7. The computing device of claim 2, wherein to label each pixel in the window, the one or more processors are further configured to:
generate, for each respective label of the plurality of labels, a corresponding bitmask that indicates locations of a corresponding one or more pixels labeled with the respective label.

8. The computing device of claim 2, wherein to determine, based on the one or more partial speckle regions for each of the plurality of columns, the speckle size of the subject pixel, the one or more processors are further configured to:
determine, based on a count of pixels in the window having a same label as the subject pixel, the speckle size of the subject pixel.

9. The computing device of claim 1, wherein the one or more processors include a plurality of hardware units each configured to determine the one or more partial speckle regions in a corresponding column in the window.

10. The computing device of claim 9, wherein each of the plurality of hardware units is configured to determine the one or more partial speckle regions in a corresponding column in the window in a single clock cycle.

11. A method comprising:
determining, with one or more processors and for each of a plurality of columns in a window centered on a subject pixel in an image, one or more partial speckle regions;
determining, with the one or more processors and based on the one or more partial speckle regions for each of the plurality of columns, a speckle size of the subject pixel;
determining, with the one or more processors and based on the speckle size of the subject pixel, to remove noise associated with the subject pixel from the image; and
removing, with the one or more processors, the noise associated with the subject pixel from the image.

12. The method of claim 11, wherein to determining, for each of the plurality of columns in a window associated with a subject pixel in the image, one or more partial speckle regions further comprises:
labeling, with the one or more processors, each pixel in the window with a corresponding label of a plurality of labels associated with a plurality of partial speckle regions in the window, wherein the corresponding label is indicative of a corresponding partial speckle region out of the plurality of partial speckle regions in the window.

13. The method of claim 12, wherein labeling each pixel in the window further comprises:
labeling, with the one or more processors, a first pixel in a first column in the window with a first label of the plurality of labels, wherein the first label is indicative of a first partial speckle region;
determining, with the one or more processors, whether a second pixel in the first column is part of a same partial speckle region based on comparing respective motion vector values of the first pixel and the second pixel; and
based on determining that the second pixel is part of the same partial speckle region as the first pixel, labeling, with the one or more processors, the second pixel with the first label to indicate that the second pixel is part of the first partial speckle region.

14. The method of claim 12, wherein labeling each pixel in the window further comprises:
labeling, with the one or more processors, a first pixel in a first column in the window with a first label of the plurality of labels;
determining, with the one or more processors, whether a second pixel in the first column is part of a same partial speckle region based on comparing respective motion vector values of the first pixel and the second pixel; and
based on determining that the second pixel is not part of the same partial speckle region as the first pixel, labeling, with the one or more processors, the second pixel with a second label of the plurality of labels to indicate that the second pixel is part of a second partial speckle region that is different from a first partial speckle region that includes the first pixel.

15. The method of claim 14, further comprising:
determining, with the one or more processors, whether a third pixel in a second column adjacent to the first pixel in the first column is part of a same partial speckle region based on comparing respective motion vector values of the first pixel and the third pixel; and
based on determining that the third pixel is part of the same partial speckle region as the first pixel, labeling, with the one or more processors, the third pixel with the first label to indicate that the third pixel is part of the first partial speckle region with the first pixel in the first column.

16. The method of claim 15, wherein determining whether the third pixel in the second column is part of the same partial speckle region further comprises:
determining, with the one or more processors and based on a connection map that indicates one or more connections between pixels of the image, that the third pixel in the second column is part of the same partial speckle region.

17. The method of claim 12, wherein labeling each pixel in the window further comprises:
generating, with the one or more processors and for each respective label of the plurality of labels, a corresponding bitmask that indicates locations of a corresponding one or more pixels labeled with the respective label.

18. The method of claim 12, wherein determining, based on the one or more partial speckle regions for each of the plurality of columns, the speckle size of the subject pixel further comprises:
determining, with the one or more processors and based on a count of pixels in the window having a same label as the subject pixel, the speckle size of the subject pixel.

19. The method of claim 11, wherein the one or more processors include a plurality of hardware units each configured to determine the one or more partial speckle regions in a corresponding column in the window.

20. A computer-readable storage medium storing instructions thereon that when executed cause one or more processors to:
determine, for each of a plurality of columns in a window centered on a subject pixel in an image, one or more partial speckle regions;
determine, based on the one or more partial speckle regions for each of the plurality of columns, a speckle size of the subject pixel;
determine, based on the speckle size of the subject pixel, to remove noise associated with the subject pixel from the image; and
remove the noise associated with the subject pixel from the image.
